(19) United States
(12) Patent Application Publication
(10) Pub. No.: US 2017/0372310 A1
(43) Pub. Date: Dec. 28, 2017

(54) SECURE KEY BASED TRUST CHAIN AMONG USER DEVICES

(71) Applicant: PAYPAL, INC., San Jose, CA (US)

(72) Inventors: Srivathsan Narasimhan, Saratoga, CA (US); Srinivasan Rangaraj, Cupertino, CA (US); Aravindan Ranganathan, San Jose, CA (US)

(21) Appl. No.: 15/193,487

(22) Filed: Jun. 27, 2016

(51) Int. Cl. G06Q 20/40; H04L 29/06

(52) U.S. Cl. CPC G06Q 20/401; H04L 63/107; H04L 63/0853; H04L 63/0428; H04L 63/06; H04L 63/083

(57) ABSTRACT

Systems and methods for providing a secure key based trust chain among several user devices are disclosed. An example method includes, obtaining a first request to authenticate a user on a first user device based on a user identifier; in response to the obtaining, transmitting to, a second user device, a second request to authenticate the user on the first user device. The second user device is a trusted user device on which the user has been authenticated. The method further includes, obtaining an indication that the user has approved the second request on the second user device without providing a password corresponding to the user identifier; and in response to obtaining the indication, authenticating the user on the first user device without requiring, from the user, the password corresponding to the user identifier.

### TECHNICAL FIELD

The present disclosure relates generally to user authentication across several devices, and in particular, to creating and maintaining a secure key based trust chain among several user devices.

### BACKGROUND

User authentication based on passwords, while useful, can create friction that results in loss of user convenience and business revenue. One main source of friction is of users forgetting their account credentials i.e. either user names, passwords or both. Password criteria are also getting increasingly complex to thwart outright guessing and phishing inspired hacking.

For example, requiring a user to provide a full user name and password (which are often required to authenticate the user due to security concerns) for conducting transactions with a private user account can result in user inconvenience and potentially the user switching to an alternative way of transacting, e.g., a signature-based credit card transaction or a PIN-based debit card transaction. The problem exacerbates when a user transacts on different devices, personal or public, each of which may require its own user authentication.

There is therefore a need for a device, system, and method, which reduce the amount of user authentication required for conduct transactions, especially when multiple devices are involved, while still maintaining high levels of security and preventing unauthorized transactions.

### BRIEF DESCRIPTION OF THE FIGURES

FIG. 1 is a schematic view illustrating an embodiment of a system for providing a secure key based trust chain among several user devices.

FIG. 2 is a schematic view illustrating an embodiment of a system for providing a secure key based trust chain among several user devices.

FIG. 3 is a flow chart illustrating an embodiment of a method for providing a secure key based trust chain among several user devices.

FIG. 4 is a sequence diagram illustrating an embodiment of a method for providing a secure key based trust chain among several user devices.

FIG. 5 is a schematic view illustrating an embodiment of a method for authorizing, though a trusted device, a transaction being conducted on an untrusted device.

FIG. 6 is a flow chart illustrating an embodiment of a method for providing a secure key based trust chain among several user devices.

FIG. 7 is a schematic view illustrating an embodiment of a computing system.

FIG. 8 is a schematic view illustrating an embodiment of a user device.

FIG. 9 is a schematic view illustrating an embodiment of a hardware architecture of a trust zone.

FIG. 10 is a schematic view illustrating an embodiment of a software architecture of a trust zone.

FIG. 11 is a flow chart illustrating an embodiment of a method for providing a secure key based trust chain among several user devices.

FIG. 12 is a schematic view illustrating various models for a trust chain.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for creating and maintaining a secure key based trust chain among several (e.g., two or more) user devices. In one embodiment, after receiving, from a tablet computer, a user request to log into an application, e.g., a payment application that requires either (1) a user name and a corresponding password or (2) a fingerprint-based user authentication, a server system identifies a trusted device of the user, e.g., the user's smartphone, and transmits to the smartphone, a verification request to approve or deny the request to login on another user device, e.g., the user's tablet computer. If the user approves the request on the smartphone, then the tablet computer can be deemed another trusted device of the user. A secure key (also referred to as a key in the present disclosure) can be transmitted to and stored in a secure hardware component of the tablet computer—which converts the tablet computer into a trusted device of the user—so that future logins using the same user name into the payment application on the tablet computer do not require the user to provide a password.

As such, a user can create and maintain a chain of trusted devices, each of which maintains a same or different secure key associated with a user name. As such, future logins and transactions under the user name (through the payment application or any other applications) on the trusted devices within the chain would not require the user to manually provide passwords, while maintaining security of transactions performed through the different user devices.

The systems and methods described in the present disclosure can provide a variety of technical advantages. First, password input can be reduced or eliminated, because a user can be authenticated through a secure key stored on a trusted device, without the user having to provide a password for login purposes.

Second, session- or cookie-based communications, which are more susceptible to unauthorized access (e.g., a session-id hijack), can therefore be replaced with the secure key-based communications. Here, a secure key can serve as not only a user device side login password, but also a user device identifier when communicating with a server.

Third, fraudulent transactions can be detected. For example, if two trusted devices of a user are transacting from different locations (e.g., New York City in the State of New York and San Francisco in the State of California, which are approximately 3,000 miles from each other) at the same time, the system may consider one of these two transactions as not belonging to the user and, as a result, deny the transaction.

Fourth, user progress data (also referred to as context data or save and resume data in the present disclosure) that describe a user's work process on one application or device can be shared with other applications or other trusted devices of the user's, enabling the user to resume work on a different application or a different trusted device.

Additional details of implementations are now described in relation to the Figures.

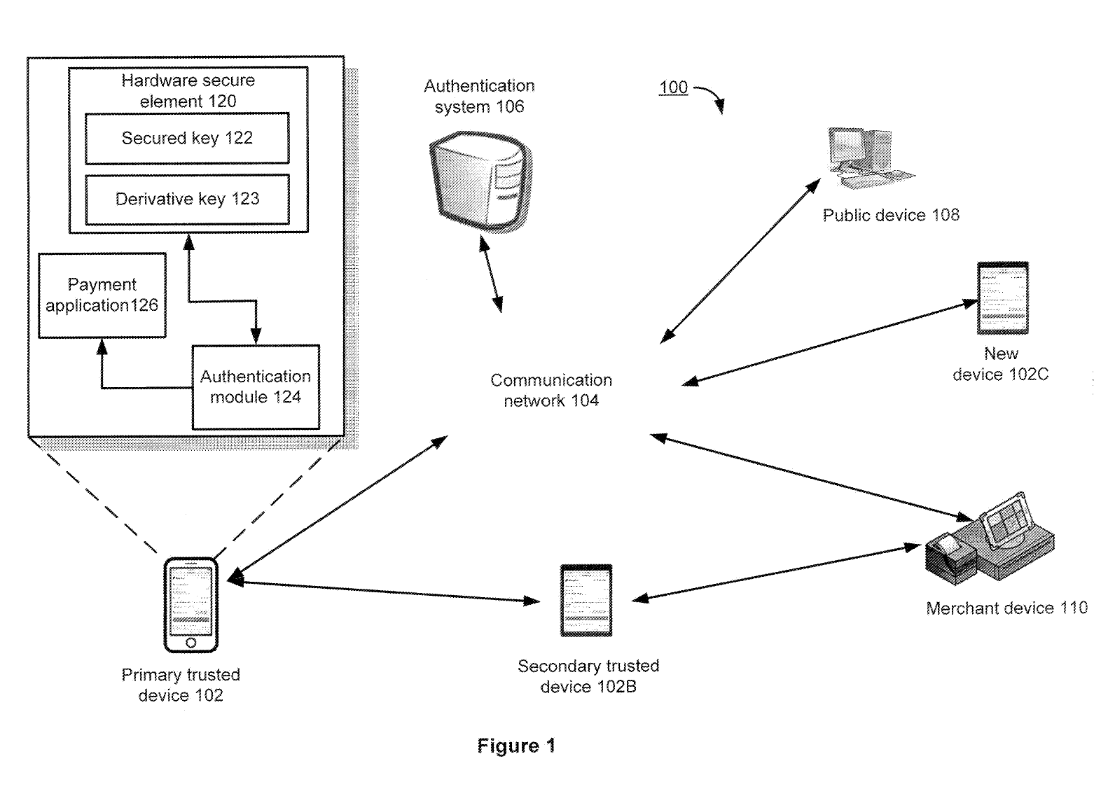

FIG. 1 is a schematic view illustrating an embodiment of a system 100 for providing a secure key based trust chain among several user devices. The system 100 may comprise or implement a plurality of servers and/or software components that operate to perform various technologies provided in the present disclosure.

As illustrated in FIG. 1, the system 100 may include a plurality of devices (e.g., 102, 102B, and 102C), an authentication system 106, a public device 108, and a merchant device (e.g., a POS device) 110 in communication over a communication network 104.

In one embodiment, the device 102 (also referred to as a user device in the present disclosure) may enable a user to authenticate herself on the device and to, after a successful authentication, conduct a transaction e.g., with a merchant device, via the communication network 104.

In some embodiments, the device 102 may include a secure element 120, an authentication module 124, and a payment application 126. The user device 102 may be implemented as a smart phone, a tablet computer, a laptop computer, a personal computer, or other computing devices.

The secure element 120 includes a hardware storage area for storing private data—such as a digital identification (ID) or a password of a user—in such a way that it is difficult to compromise (e.g., with multiple levels of encryptions or access restrictions). For example, a secure element of a device may be located in a Universal Integrated Circuit Card (UICC), a Subscriber Identity Module (SIM) card, Secure Data (SD) card or embedded Secure Element (eSE), any of which may be plugged into or otherwise connected with a user device.

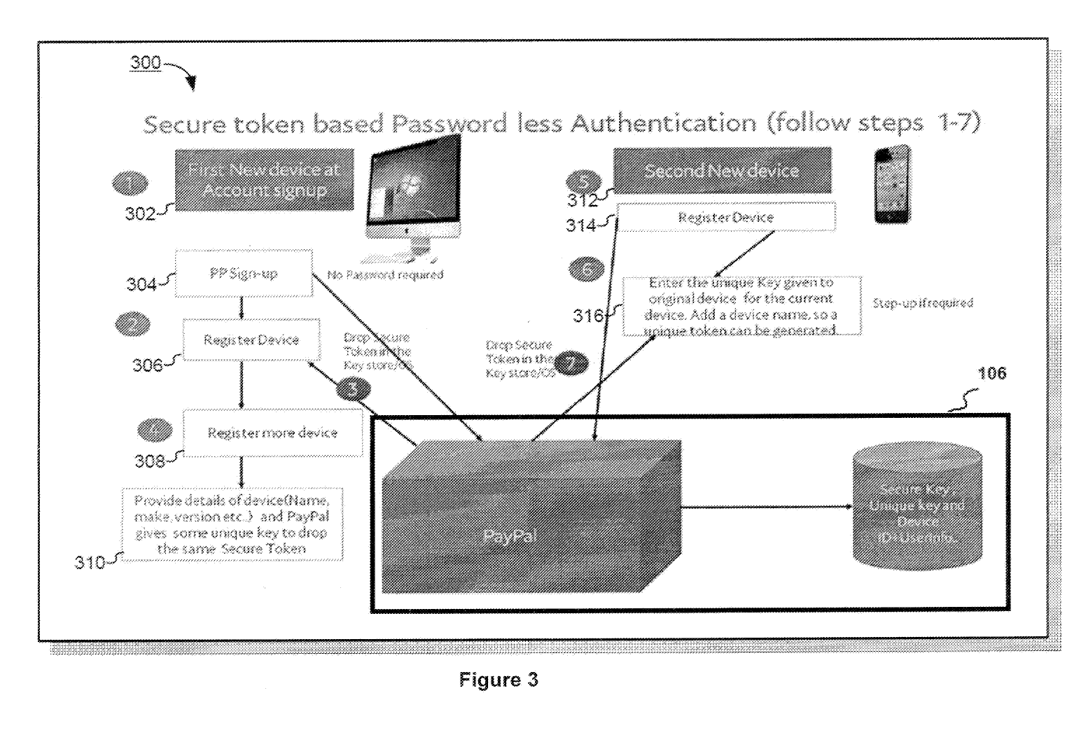

In some embodiments, the secure element 120 stores one or more keys identifying a user or her login identifier. The one or more keys may include a primary key 122 and optionally a derivative key 123. Technologies relating to key generation, storage and verification are explained in greater detail with reference to FIGS. 3-5.

In some embodiments, the user device 102 includes an authentication module 124 which may be used to authenticate a user on the user device 102. In some embodiments, the authentication application 124 may determine whether to authenticate a user on the user device based on a key stored in the secure element 102, without asking a user to provide a password. For example, after receiving a user's login identifier for the payment application 126, the authentication module 124 may search for a corresponding key in the secure element 120. If the authentication module 124 finds the corresponding key in the secure element 120, the authentication module 124 may determine the user authenticated on the device 102, e.g., for the purpose of accessing the payment application 126.

In one alternative embodiment, the authentication module 124 may collect credentials from a user and compare the collected credentials with previously accepted credentials to decide whether to authenticate a user. For example, the authentication module 154 may (1) collect, from a user, a user or device identifier such as an email address, device ID, user name, a password or PIN, an audio/video fingerprint, biometric data (e.g., voice, fingerprint, gesture), or other credential information, (2) match credential information to previously accepted or stored credential information, and (3) authenticate the user when a match occurs.

In one other alternative embodiment, the authentication module 124 may authentication a user using FIDO technologies. The passwordless FIDO technology is supported by the Universal Authentication Framework (UAF) protocol. In some embodiments, a user registers her device to the online service by selecting a local authentication mechanism such as swiping a finger, looking at the camera, speaking into the mic, entering a PIN, etc. The UAF protocol allows the service to select which mechanisms are presented to the user.

The second factor FIDO technology is supported by the Universal Second Factor (U2F) protocol. This technology allows online services to augment the security of their existing password infrastructure by adding a strong second factor to user login. The user logs in with a username and password as before. The service can also prompt the user to present a second factor device at any time it chooses. The strong second factor allows the service to simplify its passwords (e.g. 4-digit PIN) without compromising security.

In some embodiments, a device 102 uses another element that is as secure as the secure element, when the secure element is not available, e.g., not feasible to install a secure element on the device. The other element may be a software package that encrypts user credentials.

The payment application 152 may be used, for example, to initiate a payment from a user account (e.g., maintained by a payment service system) to a payee (e.g., a merchant device or another user device) over the communication network 104. The payment application 152 may be implemented as a smartphone app or a web browser.

In some embodiments, a user device 102 is considered a trusted device after a user registers the user device 102 with a service provider (also referred to as a device on-boarding process in the present disclosure). For example, after meeting a predefined number of authentication criteria, a user can register, with the service provider, a corresponding device identifier (e.g., a phone number or an IMEI number) that identifies the user device 102. After a successful on-boarding process, the service provider may generate a key based on the device identifier, a user identifier, or both, and store the key in a secure element of the user device 102. In some embodiments, a user may have two or more trusted devices, e.g., the primary trusted device 102 and the secondary trusted device 102B.

In some implementations, the communication network 104 communicatively interconnects one or more of the user devices 102 with each other, with the authentication system 106, and/or with a public device 108. In some implementations, the communication network 104 optionally includes the Internet, one or more local area networks (LANs), one or more wide area networks (WANs), other types of networks, or a combination of such networks.

In an embodiment, the authentication system 106 authenticates a user on one or more user devices by (1) forwarding an authentication request on a new user device (which is also referred to as an untrusted device) to a trusted device for user approval (or denial), and (2) when the request is approved, authenticating the user on the new user device. The authentication system 106 may additionally generate and store a secure key on the new user device, after which the new user device can become a trusted device.

In an embodiment, the public device 108 includes a device that is accessible to the general public or to more than a predefined number of users who are not related to each other within a predefined number of connections, e.g., strangers rather than family members. For example, the public device 108 may be a computer in a public library or a school computer lab. In an embodiment, upon determining that a device includes a public device, the authentication system 106 refrains from storing a key on the device, because storing the key on a public device, even in an encrypted form, may increase of the risk of jeopardizing private user information. In some embodiments, therefore, a public device is not deemed a trusted device by the authentication 106, regardless the frequency of user logins from the public device. In another embodiment, whether a device is public may be defined by the user and/or the service provider. For example, a home computer that the user and the user's children have access to may be designated as a public device by the user because the user may not want the children to be authenticated or have access to certain content or conduct transactions on the home computer. In an embodiment, a device is determined to be a public device if it is accessible to more than five users not residing in the same household. In an embodiment, a device is determined to be a public device if it is own by a public entity (e.g., a city government).

In an embodiment, the system 160 may create a secure key for a public device 108. The secure key may be a short-lived secure key, a one-time use secure keys with restrictions e.g., ASP limit, usage limit, and counterparty limit.

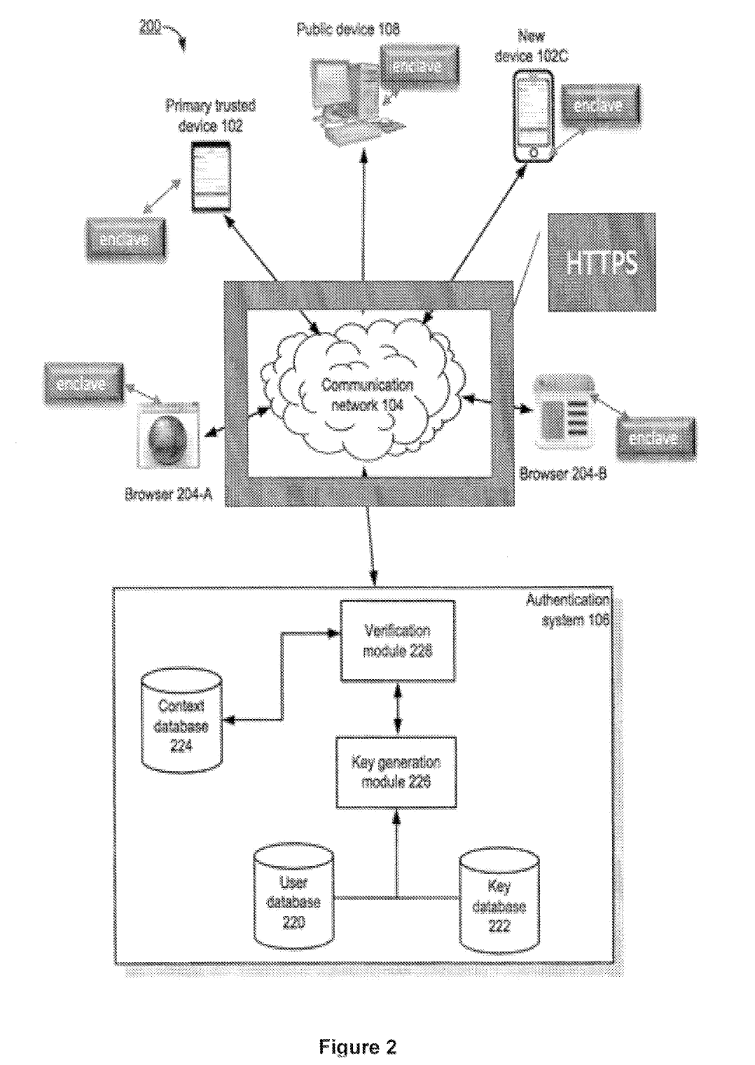

FIG. 2 is a schematic view illustrating an embodiment of a system 200 for providing a secure key based trust chain among several user devices. The system 200 may comprise or implement a plurality of servers and/or software components that operate to perform various technologies provided in the present disclosure.

As shown in FIG. 2, the system 200 may include a plurality of user devices 102 and 102C, an authentication system 106, a public device 108, one or more content viewing applications (e.g., browsers or native applications) 204A and 204B.

In an embodiment, the authentication system 106 receives a request to authenticate a user on an untrusted device (e.g., a device that does not currently have a secure key stored in its secure element, for example, the new device 102C) and transmits another request for approval to a trusted device (e.g., the primary trusted device 102). In an embodiment, responsive to a user approval of the authentication request, the authentication system 106 registers the new device 102C (in association with an identifier of the user, e.g., an application specific user identifier or a generic user identifier) as a trusted device. In an embodiment, as part of registering the new device 102C as a trusted device, the authentication system 106 stores a secure key (e.g., an encrypted password or device identifier) on the secure element of the device 102C.

In an embodiment, the authentication system 106 includes a user database 220, a key database 222, a context database 224, a key generation module 226, and a verification module 228.

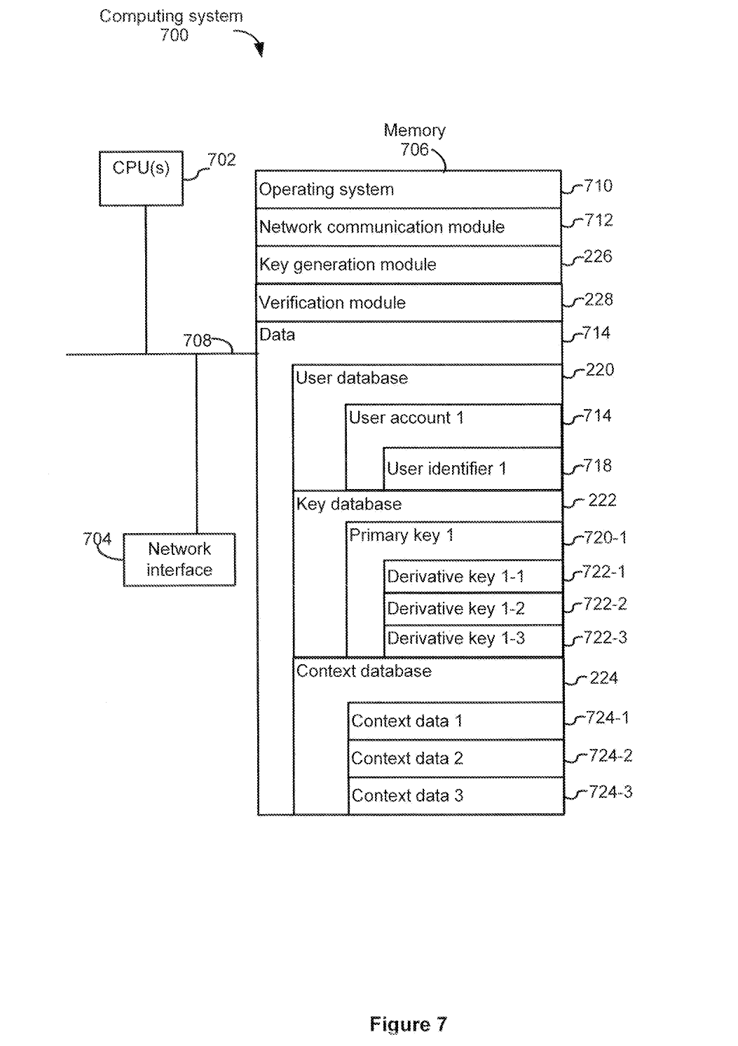

The user database 220 may store information identifying one or more user accounts (as shown in FIG. 7). A user account may include: a user identifier, a corresponding password, context data, one or more application identifiers, and one or more device identifiers.

The key database 222 may store information identifying one or more keys (e.g., primary or derivative keys). A key can be application specific, user specific, or device specific. For example, a key may help decrypt and produce a password for a specific user application; in another example, a key may be used to decrypt and produce two or more device identifiers (e.g., a primary trusted device and a secondary trusted device) for the same user. A key may be considered as a link between the application, user and device instances.

The key generation module 226 may generate one or more same or different keys for a given user identifier, after a user has successfully registered a device. In an embodiment, the key generation module 226 generates a key in accordance with a user identifier, an application identifier, a device identifier, a randomly generated Globally Unique Identifier (GUID), or any combination thereof. For example, a key may be an encrypted password for a given user identifier for logging into a given application. In another example, a key may be an encrypted device identifier that identifies a trust device.

The context database 224 may store context data identifying a user's status or progress in an application or device. For example, the context data may describe which steps of a payment transaction a user has completed and which other steps still remain (e.g., a user has completed billing address and selected payment method, but still needs to provide a shipping address and a phone number). In some embodiments, the authentication system 106 shares context data among two or more different applications, e.g., a GOOGLE CHROME browser 204-A and an APPLE SAFARI browser 204-B. Sharing context data among different applications or devices enables a user to more easily resume activity in one application what she was working on but did not complete in another application. This is particularly advantageous when these applications are running on different devices. For example, a user who was using a payment account to complete a purchase of a pair of shoes on her laptop computer can resume the purchase transaction on her smartphone while commuting to work.

The verification module 228 verifies whether a user device is a trusted device or not. When a user device is not a trusted device, the verification module 228 requests a user authentication, from a trusted device or from the user, for accessing an application on the user device. For example, if a device is not a trusted device with respect to a particular user identifier, the verification module 228 may submit a request to authenticate the user identified by the user identifier to a trusted device. For example, if a user is trying to log into a payment account on the new device 102C, the authentication system may determine that the new device 102C is not a trusted device and therefore requests a user approval on the primary trusted device 102.

FIG. 3 is a flow chart illustrating an embodiment of a method 300 for providing a secure key based trust chain among several user devices. The authentication system 106, for example, when programmed in accordance with the technologies described in the present disclosure, can perform the method 300.

In some embodiments, the first device where a user registers a user identifier (as opposed to logging into an account using an existing user identifier) is considered the primary trusted device. For example, as shown in FIG. 3, a user is registering (304) a payment account on the desktop computer 302. As part of the registration, the user may verify her identity by answering security questions (e.g., the name of her best female high school friend) or providing information uniquely identifying the user (e.g., the user's Social Security Number and Date of Birth) or confirm a phone number by sending a 1-time code. The verification system may use a plurality of methods that may or may not involve the user to ascertain whether the user is who she is claiming she is.

Upon a successful identity verification, the user can register (306) the device (e.g., the desktop computer 302) with a service provider of the payment account (e.g., the PAYPAL Inc.). In some embodiments, registering the device includes providing (310) a device identifier (e.g., an IMEI number of a phone) or other information (e.g., uniquely) identifying the device (e.g., a device name, a device's make and model, and a device version number) to the authentication system 106, which can register the device identifier in the user database 220 and generate a key based on the device identifier or the user identifier, or both.

In some embodiments, the user can, e.g., using the on-boarding process, register (308) two or more devices as trusted devices in association with a same user identifier. For example, the user can log into a payment application on the two or more devices with the same user identifier without having to provide a password.

In some embodiments, the user can register two or more devices as trusted devices in association with different user identifiers (e.g., for different application). For example, a user may register her tablet computer (that she shares with her roommate) as a trust device for the user's news feed account, but not the user's online banking account (which demands a higher level security).

This part of the device registration (e.g., steps 304-308) is sometimes referred to as the initial registration process or the on-boarding process.

Upon a successful registration, the authentication system 106 may generate a key and stores the key in a secure element of a registered user device, after which time the registered user device can become a trusted device (e.g., with respect to the user identifier).

Steps 314 and 316 describe a password-less user authentication on an untrusted (e.g., new) device 312.

To authenticate on an untrusted device, a user may use a manual registration process. For example, the user may provide the same user identifier as well as the key assigned to the device 302 to the authentication system 106. In some embodiments, a key assigned to a trusted device is an encryption code (e.g., the string “ACD999”).

Based on the same user identifier and the key, the user can then register the new device 312. Note that in this manual registration process, the new device 312 is registered without requiring the user to provide information uniquely identifying the user, unlike what was required from the user (e.g., at steps 306 and 308) during the initial registration of the primary trusted device. Once the new device 312 is successfully registered, the authentication system 106 may generate a key for the new device 312 and store the key in the secure element of the new device 312.

Alternatively, the user may use an automatic registration process. For example, upon detecting a user request to register the new device 312 under a given user identifier, the new device 312 transmits the request (e.g., including the user identifier) to the authentication system 106.

The authentication system 106, based on the user identifier provided, identifies one or more trusted devices associated with the user identifier, e.g., a primary trusted device and one or more secondary trusted devices.

The authentication system 106 then transmits, to a selected trusted device, a request for user approval of the authentication request on the new device 312. Upon obtaining a user approval from the trusted device, the authentication system 106 authenticates the user (as identified by the user identifier) on the new device 312.

Note that in this automatic password-less registration process, the new device 312 is also registered without requiring the user to provide information identifying the user, e.g., user or account credentials, the password for the user identifier or an answer to a security question. This is advantageous, as the user can complete user authentication on the new device with less effort, e.g., without having to provide, on a POS machine, a full user name and the corresponding password for accessing a payment account to pay a merchant, as well as with less risk (e.g., greater security), as private user information (e.g., a user password) was not required from the user.

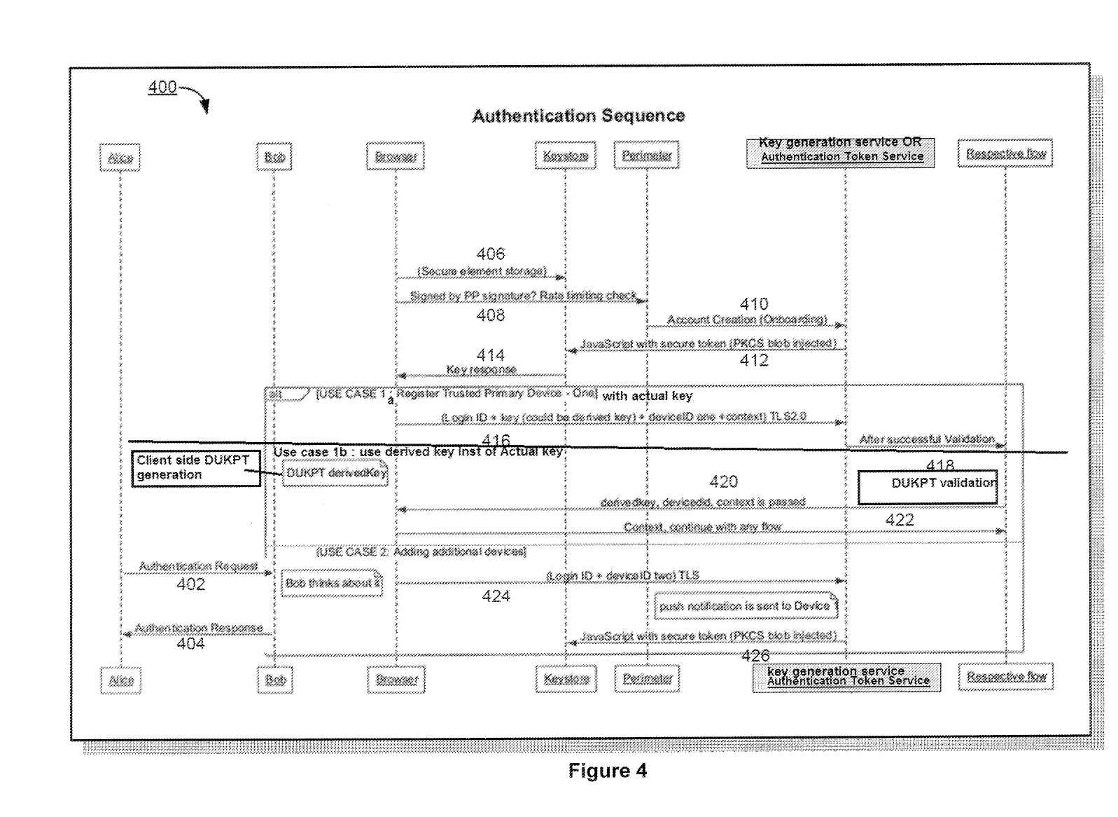

FIG. 4 is a flow chart illustrating an embodiment of a method 400 for providing a secure key based trust chain among several user devices. The system 108, for example, when programmed in accordance with the technologies described in the present disclosure, can perform the method 400.

In some implementations, the method 400 includes requesting a second user on a second device to authenticate a first user on a first device (different from the second device). For example, user Alice and user Bob may share the same user name for a payment account, e.g., because they are husband and wife.

Therefore, when user Alice tries to log into the payment account on her smartphone (which is not a trusted device with respect to the payment account), user Bob receives a message 402 asking him to either approve or deny Alice's request to authenticate herself for logging into the payment account. User Bob can send a response 404 to approve user Alice's login request.

In some implementations, two applications (e.g., a browser A and a browser B) running on a same computing device can be considered as two separate devices, for the purpose of user authentication. For example, when the browsers A and B communicate with the authentication system using (1) different individual sessions and do not (or not able to) share a session ID with each other or (2) different communication secure keys, the authentication system may treat the browsers A and B as different devices, e.g., even though browsers A and B are running on a same laptop computer.

In these implementations, each browser may have its own key stored (406) in the secure element of the user device. A key store is, in some embodiments, a storage area within the secure element for storing one or more keys in association with each other, with a given user identifier, with a given device identifier, or with any combination thereof. In some implementations, a key store stores a subset of keys stored in the key database 222. A key store therefore is sometimes referred to as a local key database.

Steps 408-414 describe how a user may, in a browser environment, register a trusted device, using a process similar to that for registering a user device (e.g., 304-310), as described with reference to FIG. 3.

Steps 416-422 describe (1) how context data can be shared between applications (e.g., from a first browser to a second smartphone app and vice versa) and (2) after receiving updated context data from one application, how to continue user progress in the other application based on the updated context data.

For example, a user may, after logging in to an online payment account, place five items in a shopping cart using a GOOGLE CHROME browser on her smartphone while commuting to home. After arriving home, the user can log into the payment account in her home computer's APPLE SAFARI browser and continue the checkout process for the five items she placed in the shopping cart earlier. For example, the user may complete the billing address as well as the payment information and complete the transaction using the SAFARI browser on her home computer.

Here, the context data (e.g., which items have been placed in the shopping cart and that the user was in the middle of a check-out process) is passed from the GOOGLE CHROME browser on the user's smartphone to the APPLE SAFARI browser on the user's home computer—through an authentication system associated with the user's payment account.

Note that, in some embodiments, context data is passed between different devices after these devices are considered trusted devices of the user. In these embodiments, context data is accompanied by keys when passed between different devices or applications. Because these keys (the same primary key or one primary key with many secondary keys) can uniquely identify the user name for the payment account, the user can access the payment account.

Also note that accompanying data communications between a user device and the authentication system with a key can enable a secure key-based authentication between the user device and the authentication system. These technologies can therefore reduce the need for session-based communications between the user device and the authentication system. This is technically advantageous, as the session-based communications are more susceptible to unauthorized access (e.g., a session ID hijacking) (resulting in improved data security) and the authentication system is not required to maintain a large number of session IDs, as required in session-based communications.

Steps 424-426 describe how a new (and thus untrusted) device may be registered as a trusted device associated with a user login, without requiring a user to provide a corresponding password, in a manner similar to that for registering a second new device (e.g., steps 312-314), as described with reference to FIG. 3.

Stated in a different way, at step 406, a browser may accesses a Secure Key (SK) in the secure element. At step 480, different actions may be taken based on the SK check at step 460.

If the device on which the browser is executing has no secure key (SK) present in its secure element, then the browser may initiate a request to the authentication server with all the signup credentials.

These credentials may be provided to the Key Generation Service (KGS) to generate SK and transmits the SK back to the browser. The browser may store the SK in the secure element on the device on which the browser is executing. The SK may be stored in association with the corresponding public login credentials (e.g., the username).

If the device on which the browser is executing has a corresponding SK present in its secure element, the browser sends the SK with the context data to the server. The logion credentials are validated at the KGS, and the context is passed on to the business flows to render the page based on the context.

The user then continues with the authenticated business flow. If the SK is present and a user would like to switch user login (e.g., by selecting the “Not you, Bob?” link), the SK will be retrieved based on the public credential of the new user.

If the device is brand new out of the box, the user will register this device by providing the user credentials.

A push notification (PN) will be sent to the trusted primary device (TPD). The user then confirms the registry of the new device from the TPD. The server now pushes the corresponding SK for the TPD into the ND. Now the ND is ready for a passwordless experience.

At step 410, the system can onboard the user based on the checks at step 408.

If the device on which the browser is executing has no secure key (SK) present in its secure element, an account may be created. The SK may be stored in the device's secure element. Alternatively, if the device on which the browser is executing has no secure key (SK) present in its secure element, various different actions may be taken.

If the SK is present and the user is requesting to switch to a different user login (e.g., by selecting the “Not you, Bob?” link), the respective user is taken to the different work low based on the context.

If the device is brand new out of the box, then a PN is sent to the TPD. At step 412, a key validation or generation is carried out.

If SK is present, then SK may be validated by Key Management service (KMS); if SK is not present, then SK may be generated by KMS and transmitted back to the browser (or app). The browser (or app) then uses the API to store the SK in the secure element of the device.

At step 414, the key store may respond to the browser/app on a successful storage of the SK. At step 416, the user ID, the SK, the device ID, the application context data are passed to the KMS for storage.

Steps 418-420 describe a similar implementation of the above methods, but with a derived key of the actual key. The derived key can be unique in each transaction.

After the SK is validated, authentication system may take various actions depending in the context.

Steps 424-426 describe registering additional devices. For example, at step 424, a new device may be registered using a login ID and a device ID; at step 426, a PN is sent to the primary trusted device to authenticate the new device. The same process described at steps 406-408 may be followed for saving and restoring context data on a new device.

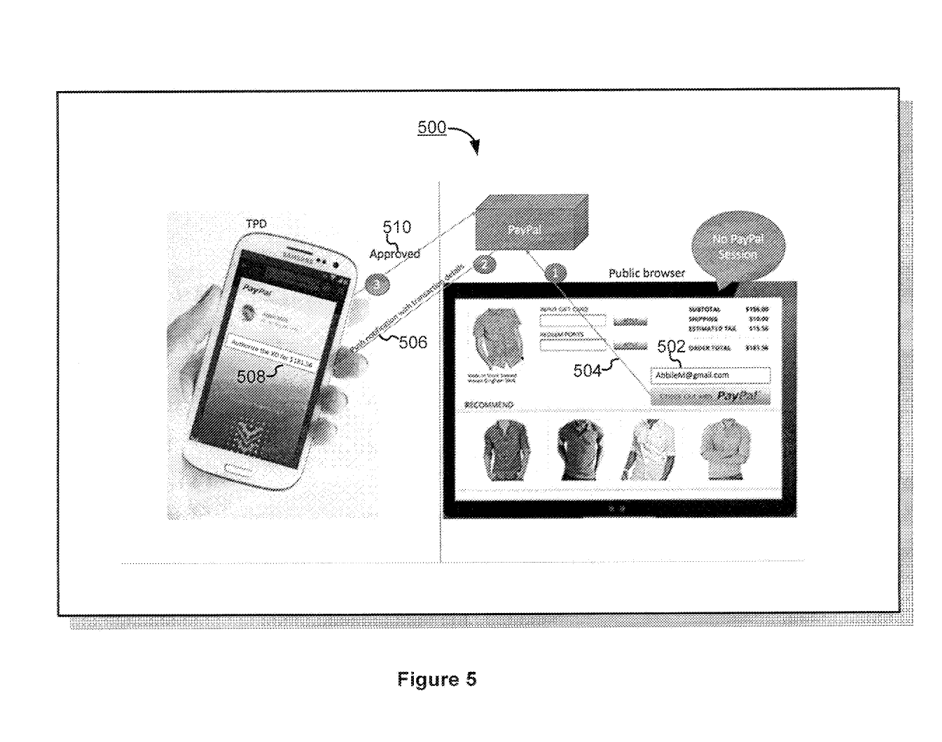

FIG. 5 is a schematic view illustrating an embodiment of a method 500 for authorizing, though a trusted device, a transaction being conducted on an untrusted device (e.g., a new device or a public device). The user device 102, for example, when programmed in accordance with the technologies described in the present disclosure, can perform the method 500.

As shown in FIG. 5, when a user is conducting a transaction on a public device (e.g., a POS device or a public computer), the authentication system 106 may not find a key corresponding to the user identifier 502 present on the public device, because as explained in other parts of the present disclosure, the authentication system 106 may not store keys on public devices.

After not being able to locate the corresponding key (e.g., the key corresponding to the PAYPAL account user name AbblleM@gmail.com), the authentication system obtains (504) the user identifier 502 from the public device. The authentication system then determines a trusted device (e.g., a primary trusted device or a second trusted device) associated with the user identifier 502 and transmits (506) a request to authenticate the user (as identified by the user identifier 502) on the public device, to the trusted device.

As shown in FIG. 5, the request 508 may include presenting the user's name (e.g., “XO”) or the user login name (e.g., “AbblleM@gmail.com”) as originally provided on the public device, as well as the amount being transacted (e.g., “$181.56”). A user can approve (510) the request on the trusted device, which enables the transaction on the public device to go through.

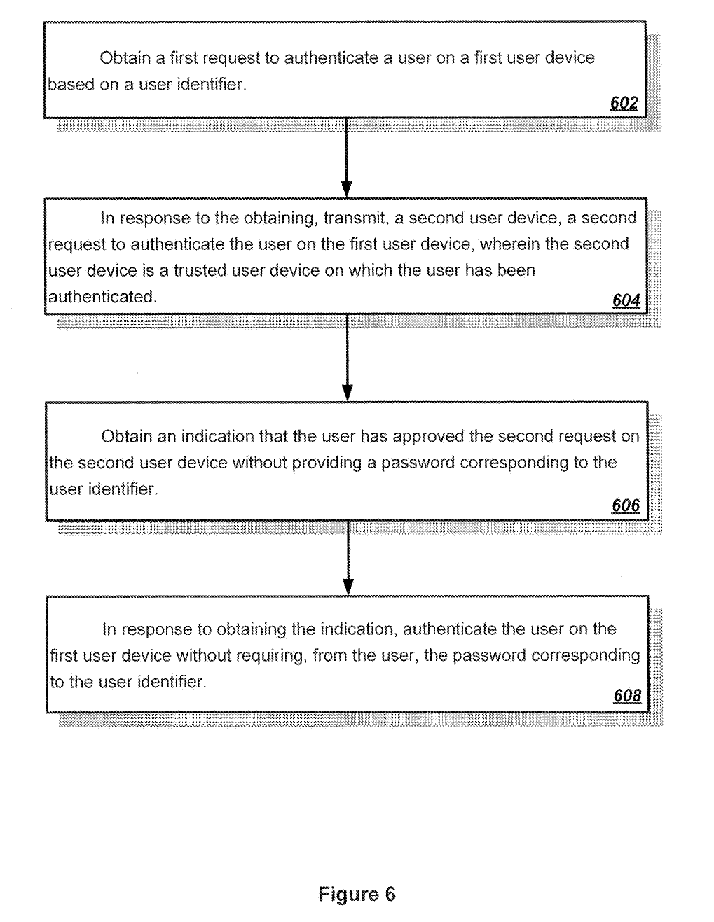

FIG. 6 is a flow chart illustrating an embodiment of a method 600 for providing a secure key based trust chain among several user devices. The authentication system 106, for example, when programmed in accordance with the technologies described in the present disclosure, can perform the method 600.

In some embodiments, the method 600 includes obtaining (602) a first request to authenticate a user on a first user device based on a user identifier.

In some embodiments, the method 600 further includes, in response to the obtaining, transmitting to (604), a second user device, a second request to authenticate the user on the first user device.

In some embodiments, the authentication system transmits the second request to the second user device, because the second user device has been deemed a trusted device of the user, e.g., using the on-boarding process described with reference to FIG. 3.

In some embodiments, the method 600 optionally performs an on-boarding process on the second user device, which includes in response to authenticating the user on the second user device, storing a second secure key within a hardware secure element of the second user device.

For example, during an on-boarding process for a user device, after a user has passed a predefined number of identity challenges, the authentication system determines the user device is a trusted device. In accordance with this determination, the authentication system stores a key (e.g., a primary key) within the secure element of the user device.

In some embodiments, the method 600 also includes obtaining (606) an indication that the user has approved the second request on the second user device without providing a password corresponding to the user identifier. For example, when a user is approving a request to authenticate the user on an untrusted device, the user does not need to provide a password even on the trusted device (the device on which the request for approval is being processed). This is because a trusted device already has a key stored in its secure element, and the authentication system can automatically detect the presence of the key and thus does not require the user to provide a password.

The method 600 also includes, in response to obtaining the indication, authenticating (608) the user on the first user device without requiring, from the user, the password corresponding to the user identifier. For example, because the user has already approved the authentication request on the trusted device, the authentication system automatically authenticates the user (or a different user) on the first user device and may convert the first user device into an additional trusted device, e.g., when the first device is not a public device.

In some embodiments, the authentication system determines whether a device is a public device based on an address (e.g., the IP address or a physical address) associated with the device. For example, if a computer has an IP address belonging to a public university, then the authentication system may deem the computer a public device. For example, if a computer is identified as physically located inside a city-own public library or a grocery store, then the authentication system may deem the computer a public device.

In some embodiments, the method 600 optionally includes: in response to obtaining the indication, generating (610) a first secure key based on a device identifier of the first user device; and storing the first secure key on the first user device. For example, once a user device is deemed a trusted device, the authentication system may apply one or more encryption algorithms on the device identifier (and optionally on the user identifier) to produce the first secure key. The one or more encryption algorithms may include symmetric algorithms or asymmetric algorithm. The one or more encryption algorithms may include the triple DES algorithm, the RSA algorithm, the blowfish algorithm, the two fish algorithm, and the AES algorithm.

When there are several trusted devices, the trusted device to which the request to authenticate the user on the first user device is sent may be selected dynamically based on one or more criteria, e.g., a trusted device's availability, location, battery level, network connection status, and the like. In some embodiments, therefore, the method 600 optionally includes: selecting the second user device as a primary trusted device from a plurality of trusted user devices. In some implementations, user authentication can be approved by a user through any trusted devices.

In some embodiments, the trusted device is selected based on its proximity (or lack thereof) to the first user device. For example, if first user device is a POS machine, the authentication system may determine that the user is at a merchant location trying to conduct a transaction and that the user's smartphone is also located within the merchant location (as determined by the smartphone's GPS location). Based on these determinations, the authentication system may therefore select the user's smartphone (as opposed to her personal desktop computer at home) as the trusted device.

In some embodiments, the trusted device is selected based on network connection information. For example, if the first user device is a public computer at a public library (as identified by the first user device's IP address), and the user's tablet (which is a trusted device) has wireless connected to a local computer network available at the public library, the authentication system may select the user's tablet (as opposed to her smartphone which is connected to a cellular network) as the trusted device, because the authentication request may be transmitted to the user's tablet within the local computer network with less transmission delay.

In some embodiments, a key hierarchy is provided. In some embodiments, therefore, the first secure key is generated further based on the second secure key associated with the second user device. For example, because the second user device may be considered the primary trusted device and the first computer device may be considered a secondary trusted device, the first user device may have a derivative key (derived and different from the primary key held by the second user device) that can authenticate the user on the first user device.

Implementing a key hierarchy (e.g., a primary key with one or more corresponding secondary keys) is technically advantageous, because when a key is compromised, the authentication system may disable the compromised key alone, without having to modify other keys, reducing the amount of interruption to the existing chain of trusted devices, as well as saving computing power.

In some embodiments, the trusted device includes a key management, which may (i) disable specific keys/all keys, (ii) delete specific keys/all keys, and (iii) pause and resume specific keys/all keys.

In some embodiments, the password-less authentication is triggered when a user is attempting to login on a public computer. For example, the method 600 may be performed in response to determining that the first user device is a public computing device. In some implementations, user authentication is approved by a user on a trusted device; the user is therefore not required to provide private information on a public device (e.g., a computer in a public library), reducing the risk for security compromise (e.g., improving electronic security).

In some embodiments, a method for passing context data between different trusted devices is provided.

The method may include obtaining a first request to authenticate a user on a first content viewing application executing on a first user device based on a user identifier; and in response to the obtaining, transmitting to, a second user device, a second request to authenticate the user on the first user device. The second user device is a trusted user device on which the user has been authenticated.

The method may further include obtaining an indication that the user has approved the second request on the second user device without providing a password corresponding to the user identifier; and in response to obtaining the indication, obtaining context data descriptive of information being presented to the user in a second content viewing application; authenticating the user on the first content viewing application; and providing the context data to the first content viewing application to enable presentation of the information to the user in the first content viewing application.

In some embodiments, the method optionally includes: selecting a trusted verification method from a plurality of trusted verification methods; and in response to selecting the trusted verification method, transmitting the second request to the second user device.

In some embodiments, the first content viewing application and the second content viewing application include a first browser and a second browser, respectively.

In some embodiments, the context data identify a particular stage of transaction the user is conducting on the second user device.

FIG. 7 is a schematic view illustrating an embodiment of a computing system 700, which can be the authentication system 106 shown in FIG. 1. The system 700 in some implementations includes one or more processing units CPU(s) 702 (also referred to as hardware processors), one or more network interfaces 704, a memory 706, and one or more communication buses 708 for interconnecting these components. The communication buses 708 optionally include circuitry (sometimes called a chipset) that interconnects and controls communications between system components. The memory 706 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 706 optionally includes one or more storage devices remotely located from the CPU(s) 702. The memory 706, or alternatively the non-volatile memory device(s) within the memory 706, comprises a non-transitory computer readable storage medium. In some implementations, the memory 706 or alternatively the non-transitory computer readable storage medium stores the following programs, modules and data structures, or a subset thereof:
an operating system 710, which includes procedures for handling various basic system services and for performing hardware dependent tasks;
a network communication module (or instructions) 712 for connecting the system 700 with other devices (e.g., a trusted user device, an untrusted user device, a public device, or a merchant device) via one or more network interfaces 704;
a key generation module 226 for generating or obtaining one or more keys based on a user identifier, a device identifier, an application identifier, or any combination thereof;
a verification module 226 for verifying whether a device is trusted device or not, e.g., based on whether a corresponding key can be located on the device; and
data 714 stored on the system 700, which may include a device database, a risk databases, as well as the following components:
   a user database 162 for storing information identifying one or more user accounts 714, each of which may be associated with a corresponding user identifier 718;
   a key database 222 for storing a primary key 720-1 and optionally one or more secondary keys 722-1, 722-2, and 722-3 in association with the primary key; and
   a context database 224 for storing application- or device-specific context data, e.g., 724-1, 724-2, and 724-3.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 706 optionally stores a subset of the modules and data structures identified above. Furthermore, the memory 706 may store additional modules and data structures not described above.

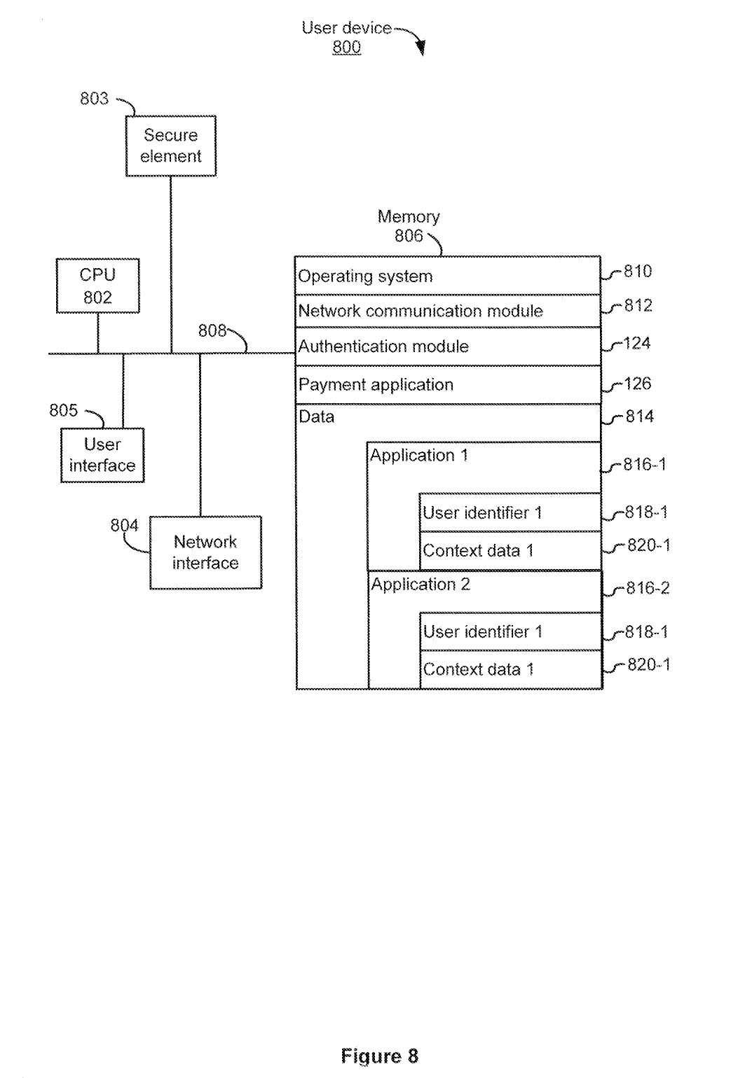

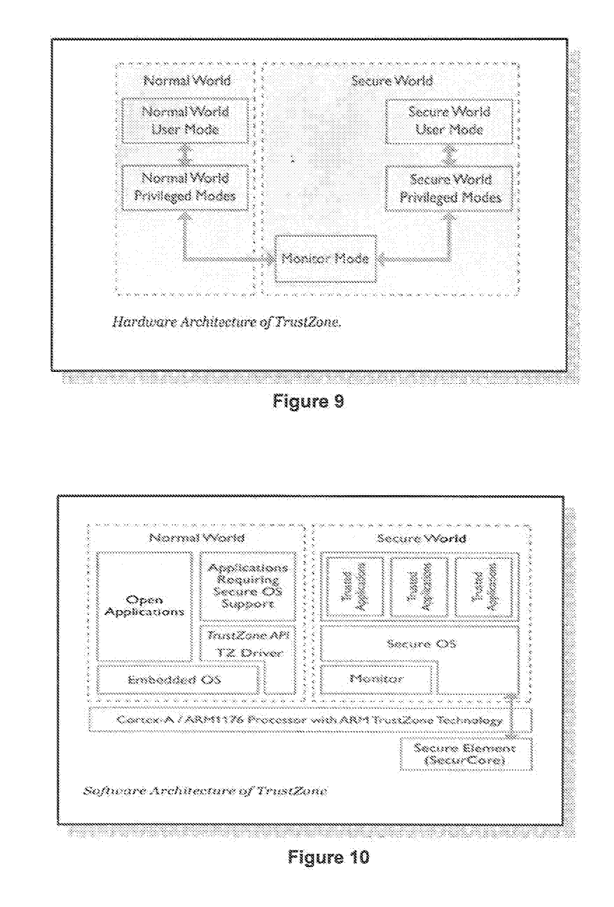

FIG. 8 is a schematic view illustrating an embodiment of a user device 800, which can be the 102 shown in FIG. 1. The device 800 in some implementations includes one or more processing units CPU(s) 802 (also referred to as hardware processors), one or more secured elements 803, one or more network interfaces 804, a user interface 805, a memory 808, and one or more communication buses 808 for interconnecting these components. The communication buses 808 optionally include circuitry (sometimes called a chipset) that interconnects and controls communications between system components. The memory 808 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 808 optionally includes one or more storage devices remotely located from the CPU(s) 802. The memory 808, or alternatively the non-volatile memory device(s) within the memory 808, comprises a non-transitory computer readable storage medium. In some implementations, the memory 808 or alternatively the non-transitory computer readable storage medium stores the following programs, modules and data structures, or a subset thereof:
an operating system 810, which includes procedures for handling various basic system services and for performing hardware dependent tasks;
a network communication module (or instructions) 812 for connecting the device 800 with other devices (e.g., the new device 102C, the public device 108, and the authentication system 106) via one or more network interfaces 804 (wired or wireless) or via the communication network 104 (FIG. 1);
an authentication module 124 for determining which user authentication methods are required based on whether a corresponding key can be located on the user device or not;
a payment application 126 for conducting transactions with (e.g., sending a payment to or receiving a payment from) a merchant device or another user device;
data 814 stored on the device 800, which may include:
   an application (e.g., a browser) 816-1 running on the user device 600 under the user identifier 818-1 with context data 820-1; and
   a different application (e.g., a different type of browser) 816-2 running on the user device 600 also under the user identifier 818-1 and with context data 820-1.

The one or more secured elements 803 may storage one or more keys (e.g., a primary key and one or more derivative keys). The device 800 may further include a location determination component (e.g., a Global Positioning System (GPS) device and a cell tower triangulation device) for providing location information of the device 800.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 808 optionally stores a subset of the modules and data structures identified above. Furthermore, the memory 808 may store additional modules and data structures not described above.

Although FIGS. 7 and 8 show a “computing system 700” and a “device 800,” respectively, FIGS. 7 and 8 are intended more as functional description of the various features which may be present in computer systems than as a structural schematic of the implementations described herein. In practice, and as recognized by those of ordinary skill in the art, items shown separately could be combined and some items could be separated.

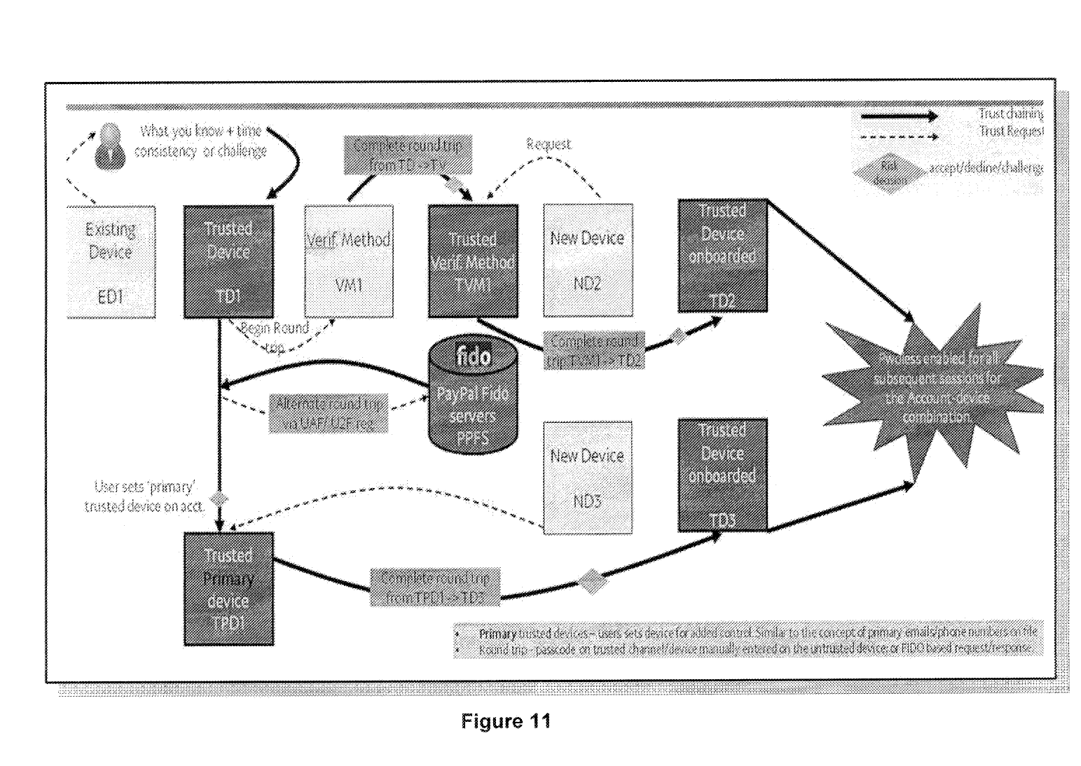

FIG. 10 is a schematic view illustrating an embodiment of a software architecture of a trust zone; FIG. 11 is a flow chart illustrating an embodiment of a method for providing a secure key based trust chain among several user devices. Different implementations of a trust zone are explained above with reference to FIG. 1-6.

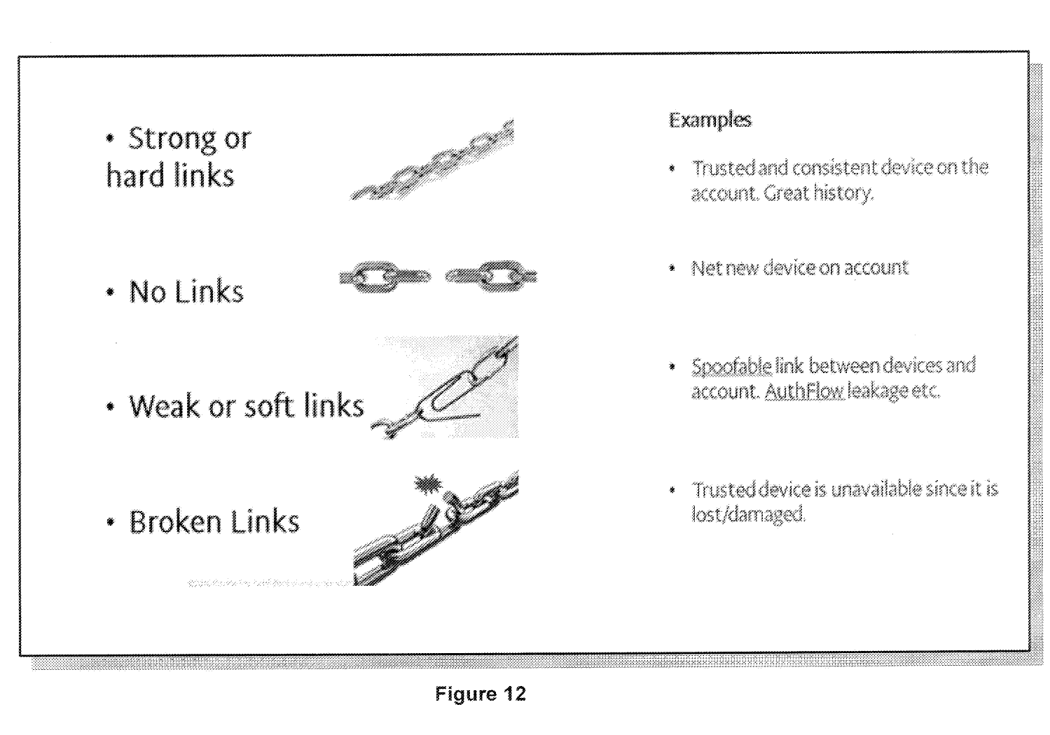

FIG. 12 is a schematic view illustrating various models for a trust chain. Different chain types can be applied to the trust chain as explained with reference to FIG. 1-6.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory; and
one or more hardware processors coupled to the non-transitory memory and configured to execute instructions from the non-transitory memory to cause the system to perform operations comprising:
obtaining a first request to authenticate a user on a first user device based on a user identifier;
in response to the obtaining, transmitting to, a second user device, a second request to authenticate the user on the first user device, wherein the second user device is a trusted user device on which the user has been authenticated;
obtaining an indication that the user has approved the second request on the second user device without the user providing a password corresponding to the user identifier; and
in response to obtaining the indication, authenticating the user on the first user device without requiring, from the user, the password corresponding to the user identifier.

2. The system of claim 1, wherein the operations further comprise:
in response to authenticating the user on the second user device, storing a second secure key within a hardware secure element of the second user device.

3. The system of claim 2, wherein the operations further comprise:
in response to obtaining the indication, generating a first secure key based on a device identifier of the first user device; and
storing the first secure key on the first user device.

4. The system of claim 3, wherein the first secure key is generated further based on the second secure key associated with the second user device.

5. The system of claim 4, wherein the operations further comprise:
detecting the secure key as being located on the second user device; and
in response to the detecting, determining that the second user device is the trusted user device.

6. The system of claim 1, wherein the operations are performed in response to determining that the first user device is a public computing device.

7. The system of claim 1, wherein the user is authenticated on the second user device based on information, other than the password, that identifies the user.

8. The system of claim 1, wherein the operations further comprise: selecting the second user device as a primary trusted device from a plurality of trusted user devices.

9. A method comprising:
obtaining a first request to authenticate a user on a first user device based on a user identifier;
in response to the obtaining, transmitting to, a second user device, a second request to authenticate the user on the first user device, wherein the second user device is a trusted user device on which the user has been already authenticated;
obtaining an indication that the user has approved the second request on the second user device without the user providing a password corresponding to the user identifier; and
in response to obtaining the indication, authenticating the user on the first user device without requiring, from the user, the password corresponding to the user identifier.

10. The method of claim 5, further comprising:
in response to authenticating the user on the second user device, storing a second secure key within a hardware secure element of the second user device.

11. The method of claim 10, further comprising:
in response to obtaining the indication, generating a first secure key based on a device identifier of the first user device; and
storing the first secure key on the first user device.

12. The method of claim 11, wherein the first secure key is generated further based on the second secure key associated with the second user device.

13. The method of claim 12, further comprising:
detecting the secure key as being located on the second user device; and
in response to the detecting, determining that the second user device is the trusted user device.

14. The method of claim 5, wherein the operations are performed in response to determining that the first user device is a public computing device.

15. The method of claim 5, wherein the user is authenticated on the second user device based on information, other than the password, that identifies the user.

16. The method of claim 5, further comprising: selecting the second user device as a primary trusted device from a plurality of trusted user devices.

17. A system, comprising:
a non-transitory memory; and
one or more hardware processors coupled to the non-transitory memory and configured to execute instructions from the non-transitory memory to cause the system to perform operations comprising:
obtaining a first request to authenticate a user on a first content viewing application executing on a first user device based on a user identifier;
in response to the obtaining, transmitting to, a second user device, a second request to authenticate the user on the first user device, wherein the second user device is a trusted user device on which the user has been authenticated;
obtaining an indication that the user has approved the second request on the second user device without the user providing a password corresponding to the user identifier; and
in response to obtaining the indication, obtaining context data descriptive of information being presented to the user in a second content viewing application;
authenticating the user on the first content viewing application; and
providing the context data to the first content viewing application to enable presentation of the information to the user in the first content viewing application.

18. The system of claim 17, wherein the operations further comprise: selecting a trusted verification method from a plurality of trusted verification methods; and in response to selecting the trusted verification method, transmitting the second request to the second user device.

19. The system of claim 17, wherein the first content viewing application and the second content viewing application include a first browser and a second browser, respectively.

20. The system of claim 17, wherein the context data corresponds to a particular stage of a transaction the user is conducting on the second user device.
